(19) United States
(12) Patent Application Publication
(10) Pub. No.: US 2005/0222834 A1
(43) Pub. Date: Oct. 6, 2005

(54) Simulation model generation

(76) Inventor: Jackie Riley, Glasgow (GB)

Correspondence Address: RATNERPRESTIA, P O BOX 980, VALLEY FORGE, PA, 19482-0980, US

(21) Appl. No.: 10/513,231

(22) PCT Filed: Apr. 29, 2003
(86) PCT No.: PCT/GB03/01855

§ 371 Date: May 10, 2005

(30) Foreign Application Priority Data
May 1, 2002 (GB) 02009937.2

(51) Int. Cl. G06F 9/45

(52) U.S. Cl. 703/22

(57) ABSTRACT

This invention relates to generating model data for computer simulation of processes, for example generation of simulation models for hospital Accident & Emergency Departments, by providing a simplified input of information about processes and the model for unskilled users. A system and method is provided for prompting for process information in a model, where the prompts depend on previous responses to prompts that define the state of the model. In particular, the process information comprises an exclusion variable for recording whether the corresponding process should be excluded from a simulation and the prompts depend on the exclusion variable.

This invention relates to generating model data for computer simulation of processes, in particular generation of simulation models for hospital Accident & Emergency Departments.

In the field of process simulation, computer models are used to define networks of processes that have cycle times and resource constraints associated with each node. Simulation packages such as Witness® from the Lanner Group, Worcs., UK provide user interfaces for creating and editing simulation model data and running simulations.

The benefits to users of such simulation packages are well known, in that once the model is set up, the user can perform “what if” simulations by running the model and observing bottle-necks, or changing the constraints in the model and observing the effect on bottle-necks.

Although great effort is put into providing user friendly interfaces to simulation packages, setting up a model representing, for example, a hospital Accident & Emergency (A&E) department, requires considerable skill and experience of the user, even if this involves their use of templates which can be edited manually via the user interface.

It would be advantageous to provide users of a simulation package a simple means of setting up the simulation model data and automatically running a simulation.

It is an object of the present invention to provide, in a storage medium, simulation model data responsive to a simplified input of information about processes and the model.

It is a further object of the present invention to ease the mental burden of users in creating simulation models for hospital Accident & Emergency departments.

According to a first aspect of the present invention, there is provided a system comprising:
a plurality of process data items;
means for inputting process information corresponding to at least one process data item from an input unit;
means for setting said at least one process data item responsive to said input process information;
means for selecting said at least one process data item depending on the value of at least one of said process data items and activating said means for inputting process information; and
a data interface means for outputting process data items corresponding to simulation model data.

Preferably said means for inputting process information comprises stored input prompts corresponding to said process information.

Preferably said process data items comprise variables corresponding to said process information.

More preferably said process data items further comprise an exclusion variable for recording whether the corresponding process should be excluded from a simulation.

Preferably said means for selecting at least one data item is responsive to said exclusion variable.

Preferably said means for setting at least one process data item is responsive to said exclusion variable.

According to a second aspect of the present invention, there is provided a method comprising the steps of:
selecting at least one process data item depending on the value of at least one process data item;
outputting at least one input prompt corresponding to said selected at least one data item to an output unit;
inputting process information corresponding to said selected at least one process data item from an input unit;
setting at least one process data item responsive to said input process information; and
outputting process data items corresponding to simulation model data.

Optionally the method further comprises the step of activating the execution of a simulation using said simulation model data.

Preferably said output unit comprises a display unit.

Preferably said process data items comprise variables corresponding to said process information.

More preferably said process data items further comprise an exclusion variable for recording whether the corresponding process should be excluded from a simulation.

Preferably said step of selecting at least one data item is responsive to said exclusion variable.

Preferably said step of setting at least one process data item is responsive to said exclusion variable.

In order to provide a better understanding of the present invention, an embodiment will now be described by way of example only, and with reference to the accompanying Figures and Table, in which:

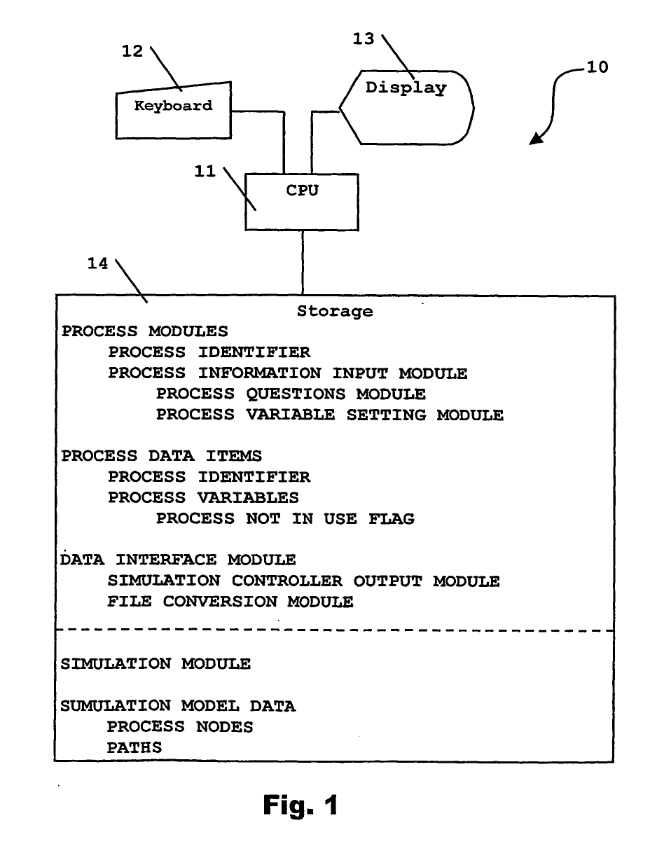

FIG. 1 illustrates in schematic form a computer and storage in accordance with the present invention;

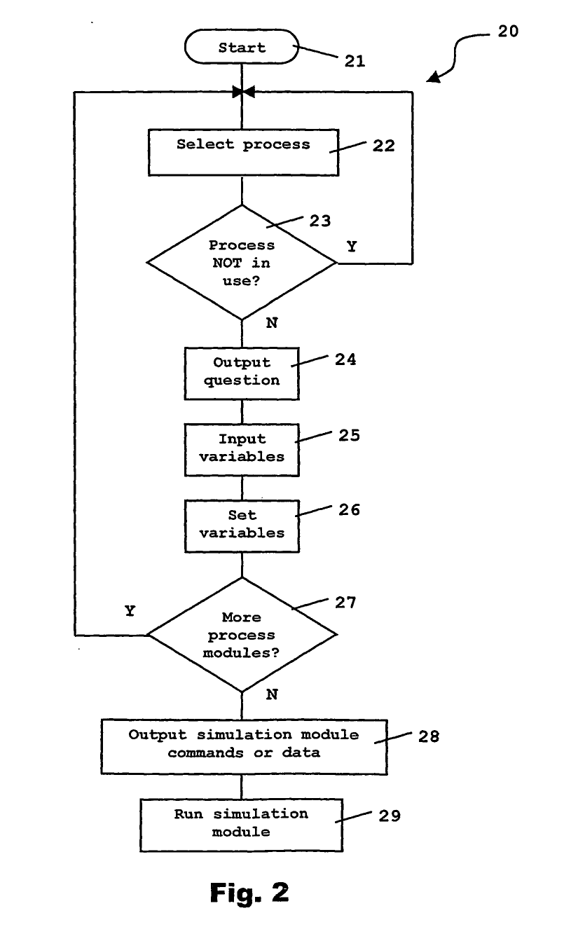

FIG. 2 illustrates a flow chart of a method in accordance with the present invention.

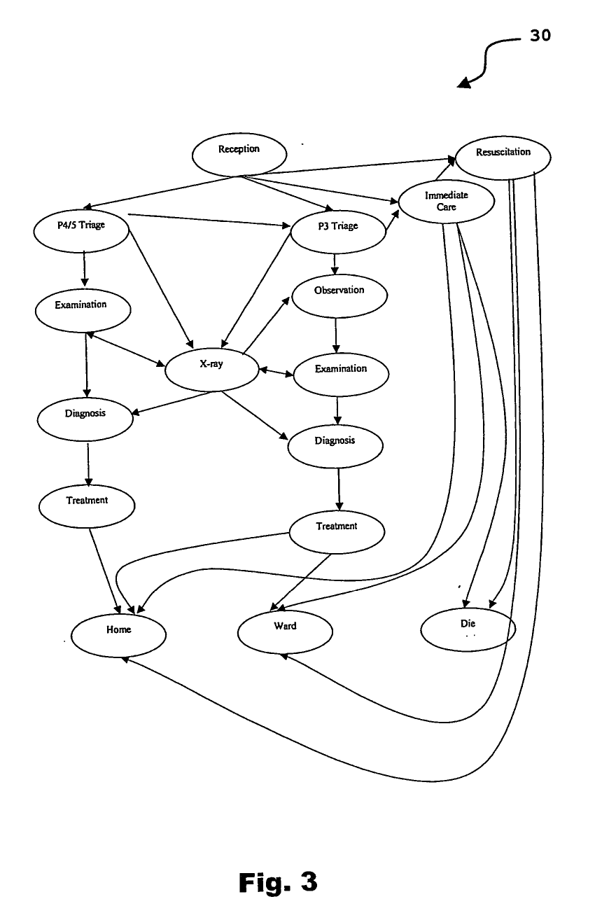

FIG. 3 illustrates a network of nodes representing a master model;

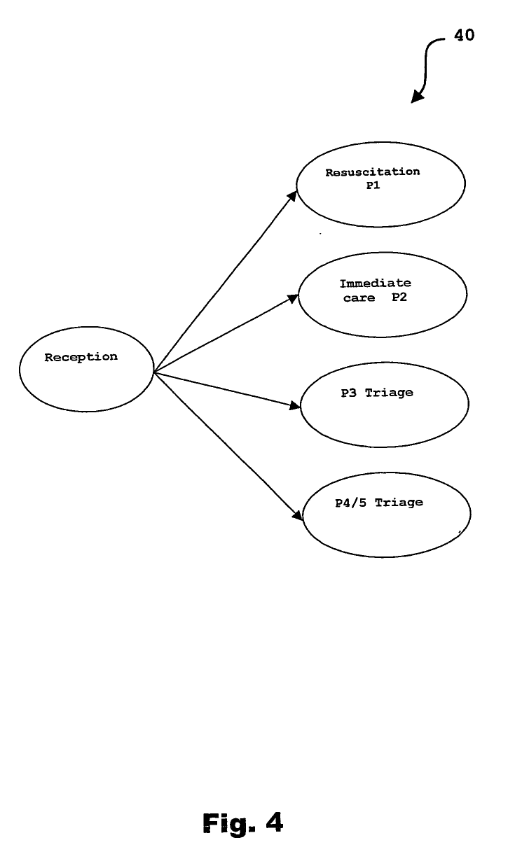

FIG. 4 illustrates an example of a sub-system on the master network;

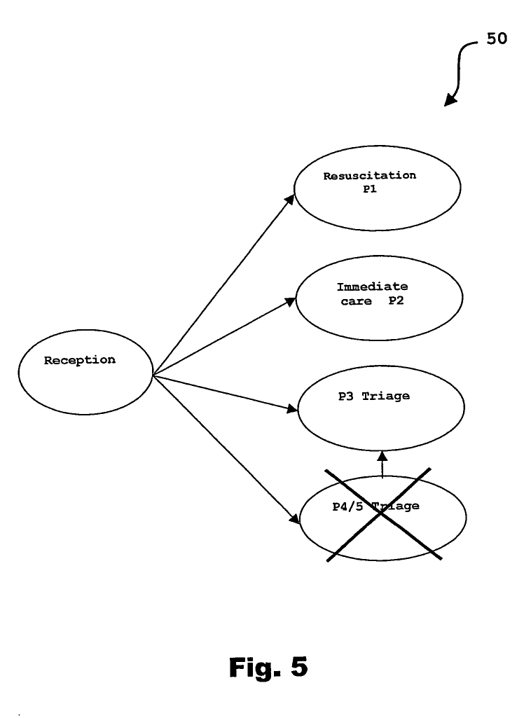

FIG. 5 illustrates an example of an alternative sub-system of the master network;

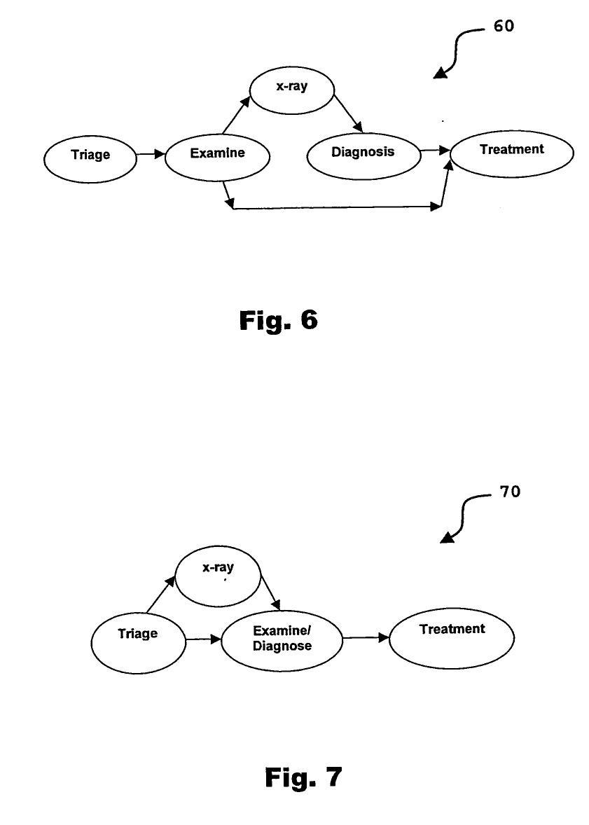

FIG. 6 illustrates the example of a path through an Accident & Emergency department for priority 4/5 category patients;

FIG. 7 illustrates an example of an alternative path to that illustrated in FIG. 6;

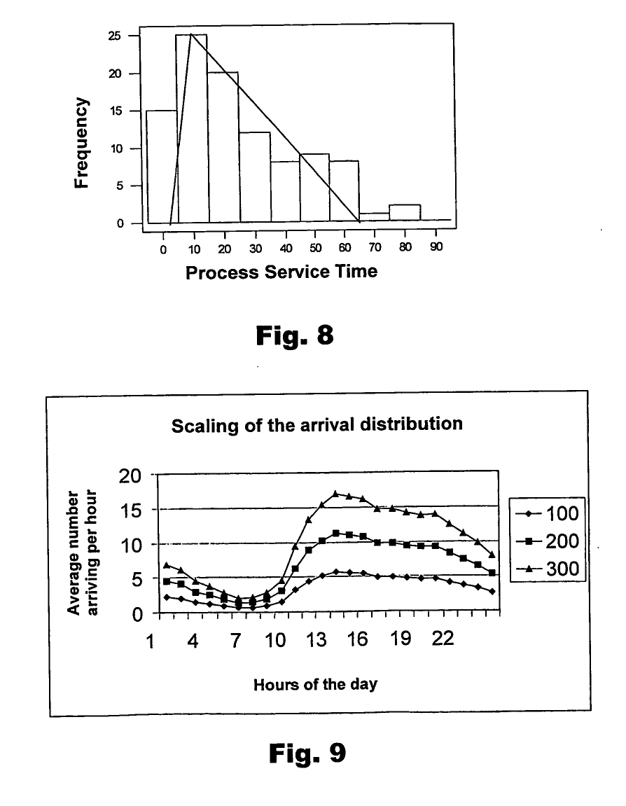

FIG. 8 illustrates a distribution of process service times for a process;

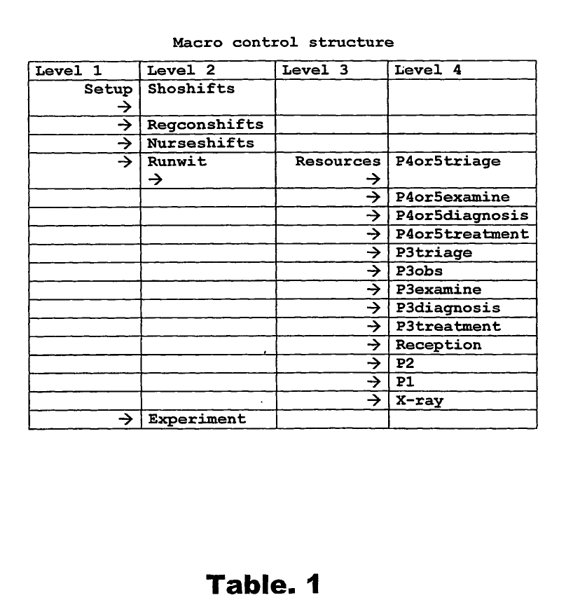

FIG. 9 illustrates the scaling of an arrival distribution versus the time of the day at an Accident & Emergency department; and

Table 1 illustrates the macro control structure

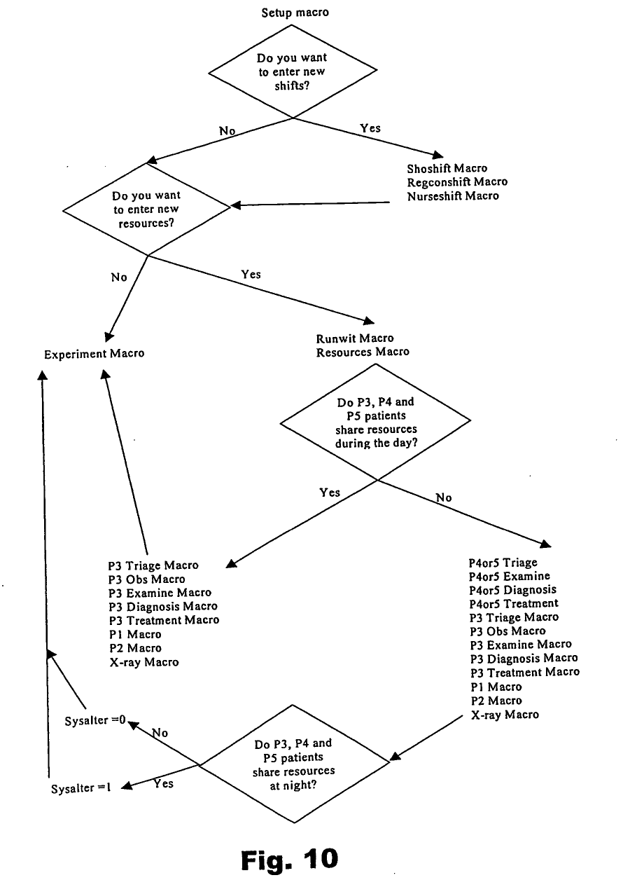

FIG. 10 illustrates a decision structure used to control the running of program macros.

The invention is a system and method that functions to provide, in a storage medium, simulation model data and optionally to execute the simulation.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

With reference to FIG. 1, a computer and storage are shown in accordance with a preferred embodiment of the present invention. The computer system 10 has a Central Processing Unit (CPU) 11, input 12 and output 13 devices and a storage device 14, e.g. a hard disk or RAM within a local computer or on a network. The storage contains programs and data. In one embodiment, each process in an A&E simulation has a corresponding Excels program macro (i.e. a process module). The macros are identified by meaningful names such as P4or5triage corresponding to the triage process for category P4 or P5 patients. On arrival, patients are categorised based on the level of care they will require from P1, the most urgent, to P5. The macros contain instructions to provide prompts and ask questions for user input about the process. Furthermore, each process has associated process data items for storing process related information, including data based on the user inputs in response to the questions.

Macros are stored that when executed pass the process data to a simulation program, either directly or via a data file.

Other global programs and data may also be stored in the computer system, for example to gather input and store the shift information about medical staff.

The storage also contains a simulation program, such as Witness™ with its associated data. The simulation might alternatively be stored and/or executed on a different computer.

FIG. 2 shows a flowchart of steps 20 in accordance with a preferred embodiment of the present invention. The system functions by selecting 22 a process macro module, but skipping 23 those processes that have been flagged as not in use, and should be excluded from simulation. The process macro has a process information input module that then asks the user 24 to input 25 responses to questions about the process, including whether the process is to be used. The user input is used to set 26 variables including the process not in use flag. The system iterates 27 through all of the process modules in a master model.

Next a data interface macro passes 28 the process data items to a simulation program by calling simulation program routines directly. Alternatively, the process data items may be saved to a file for subsequent reading in to the simulation program.

A final step is the automatic running 29 of the simulation program. The model that is run contains only processes that have been confirmed via a question and answer session with the user.

For the resulting simulation model to be capable of representing any Accident and Emergency department (e.g. in Scotland), in its master version it must contain every aspect of Accident and Emergency care that could be within such a department. There may be no actual departments that contain all aspects, but it must be assumed that it is entirely feasible that the situation could arrive. The first step in developing a model is to visit the largest accessible Accident and Emergency department. A data capture system can provide the majority of the necessary data. The missing data can be estimated by calculating backward from the total time a patient spent in the department, which may be available.

The modelling and validation phases may be completed with the assistance of members of staff from the department, who comment on the model. Through an iterative process of revisions the final master model can be agreed.

Differences between Accident and Emergency departments include:
A separate area where patients can be monitored if required, called the immediate care area and would generally be for P2 category patients.
The resuscitation bays in may include x-ray gantries, therefore staff from the x-ray area are not required to use a portable x-ray machine.
All areas of the department may be open 24 hours a day, as opposed to departments where the area used for P4/5 category patients' closes during the night.

The investigation of Accident and Emergency departments does not only provide information on all aspects to be included in the master model. It may also highlight the basic processes that all departments will have although the quantity will change from venue to venue. Quantity here implies both the capacity of the process and the workload with which it can be faced.

FIG. 3 illustrates the complete network 30 representing the processes in the master model. Patients could also be transferred to another hospital, but in terms of the model this is equivalent to the “home” node. The physical processes within the simulation model can be regarded as components of a network. The master network making up the master model will contain all possible nodes. Closing off certain nodes, assuming the connectivity of the network is not compromised can provide a variety of subsystems of the master network.

FIG. 4 illustrates an example of a subsystem 40 of the master network. The master network will have four areas for the patients to be directed to after reception.

However, if a hospital does not have, say, separate areas to treat the P4/5 patients and the P3 patients then they would all be dealt with together therefore the network would be altered to look as illustrated in FIG. 5. The patients who would have been directed to the P4/5 Triage facility if it existed would be redirected to the P3 Triage facility.

Once the complete set of processes has been identified, directions would be in place to complete the network even if certain nodes are missing. This will result in smaller, but complete Accident and Emergency systems being represented.

The detail of every process within the system must be specified. This detail includes the location of the patients prior to the particular process (input detail) and the location to which the patients are sent after the process is completed (output detail). The input and output detail can allow for various locations to be specified.

Attributes and variables are used within the syntax of the detail to indicate if the node representing a particular process has or has not to be included for the desired configuration of the model.

Each process that could be omitted (some processes are essential to all Accident and Emergency departments) from the configuration has a variable called processnameUSE. If the particular process exists the variable is set to zero, if it does not exist it is set to 9999.

The value of the variable has implications for the process prior to the process the variable is linked to and also the process subsequent to it in the network.

The prior process must assess the value of the variable and send the patients either to the queue for the process if the variable equals zero or to an alternative queue if the process does not exist and therefore, if its variable equals 9999.

For the example used as illustrated in FIG. 5, where the P4/5 Triage facility did not exist, the output detail for the reception process is
IF P4or5triageUSE=9999
   PUSH P4or5 to P3triq,P3 to P3triq,RELATIVE to SHIP
ELSE
   PUSH P4or5 to P4or5triq,P3 to P3triq,RELATIVE to SHIP
ENDIF

Note: the term “to SHIP” is terminology within Witness™ to indicate that an entity is leaving the model. In this example the code that would be implemented would be
IF P4or5triageUSE=9999
   PUSH P4or5 to P3triq

The P4/5 category patients are being sent to the P3 Triage queue since the P4/5 Triage process does not exist.

By using tests like the above throughout the model, the patients are redirected around the appropriate configuration of the system.

Within the network there are two nodes in particular that have the greatest impact on the system if the processes they represent do not exist.

These are the P4/5 Triage and the Immediate Care nodes.

If the P4/5 Triage node does not exist this informs the modeller that all patients in categories 3, 4 and 5 are dealt with in the same area. In FIG. 3 this is the same as closing off the four nodes on the left-hand side.

If the Immediate Care area does not exist then all patients in categories 1 and 2 are treated together.

The implications of these alterations to the system on the detail included in other processes are clearly illustrated by the output detail of the x-ray process.

In the detail below, a series of tests are required to evaluate the destination of the different categories of patients.

```
IF TYPE = P4or5 AND ORDERP4or5xray < ORDERP4or5examine AND
P4or5triageUSE < 9999
  PUSH to P4or5examq
ELSEIF TYPE = P4or5 AND P4or5triageUSE < 9999
  PUSH to P4or5diagq
ELSEIF xb2 = 1
  PUSH to assemq2
ELSEIF TYPE = P4or5
  PUSH to P3diagq
ELSE
  PUSH to move2q
ENDIF
```

The tests above do not only involve the processnameUSE variable they are also utilising the ORDERprocessname variables. This is a second variable that is linked to some of the processes.

Not only is it common for some Accident and Emergency departments to have particular nodes omitted from their system, it is also feasible for the nodes and hence the processes to be accessed in a variety of sequences.

It is becoming more common for Accident and Emergency departments to employ specially trained nurses called Emergency Nurse Practitioners. Their role within the department is more extensive than that of a nurse, as they are qualified to assess patients, order certain x-rays and where appropriate treat patients without any intervention from a member of the medical staff. The patients usually treated by the Emergency Nurse Practitioners are within the P4/5category. Not only can this provide a fast track through the department for many minor injuries patients, it can also improve the patient flow for those whom the Emergency Nurse Practitioner send for an x-ray prior to being examined by a doctor.

With reference to FIGS. 6 and 7 that illustrate examples of paths through the department for P4/5 category patients, the use of an Emergency Nurse Practitioner can result in the sub network for P4/5 patients changing from 60 to 70.

The sub network 70 illustrates the situation where when the Emergency Nurse Practitioner examines the patient, if they require an x-ray, this is completed and then the doctor makes a diagnosis of the patients condition. Now if the patient requires an x-ray it is completed prior to seeing the doctor, therefore the doctor is only involved with the patient once, reducing the number of processes the patient goes through and therefore the time spent in the department.

Via the ORDERprocessname variable, the coding of the model enables patients to be directed around the system according to the specified configuration.

The output detail from the x-ray process above shows that the destination of the patient is different after the x-ray process, this depends on the specified order of the processes.

The patient will either be sent to the P4or5examq if the x-ray was completed prior to an examination by a doctor or to the P4or5diagq otherwise.

When comparing the different Accident and Emergency departments, it became apparent that a generic model would have to be flexible enough to cope with major, but regular alterations of the department throughout the day.

For example, as highlighted in the differences between the departments, one department may be reduced in size at night, with the closure of the area used for P4/5 category patients during the day. While the generic model is the complete system, the coding of the model has to cater for these major structural changes. When an area of the department is closed down for regular periods of time, i.e. every night, it is the coding within the reception process that is altered to implement the change.

The receptionist has to know where to send the patients at particular times of the day and therefore the coding involves a variable being set to indicate which areas shut down (if any) and then a series of comparisons are performed against the current time of the model. This ensures the patient is set to the appropriate area within the department.

An example of the coding that assess the time of day and whether or not the system changes is:
IF TIME<6000R TIME>1260 AND sysalter=1

Where sysalter is the variable that that is set to 1 to indicate the system does alter.

The temporary closing of an area not only involves the stopping of patients entering, it also involves the transfer of patients from within the area to the appropriate queue in the area that is remaining open. E.g. a patient waiting for treatment in the P4/5 area that is being closed will be transferred to the treatment queue in the P3 area that will remain open. The coding would be:

IF TIME - 1440 * (day1 − 1) > 1260 AND sysalter = 1
PULL from P4or5 out of P4or5treatq
PUSH to P3treatq

Category P4/5 patients who are who are in the x-ray area when the decision is taken to close the P4/5 are also redirected in to the P3 area after the x-ray is completed.

The whole process of closing down an area within the department involves the comparison of time and the system altering variable, at all the processes within the area being closed in addition to x-ray and reception.

In addition to information for each of the processes with regard to its position in the master model, there has to be detail added to each of the processes such as the staff required to perform the process and a cycle time distribution for the length of time the process will take.

The cycle time distribution is well described by a Triangular distribution. The Triangular distribution consists of three parameters, minimum—eliminating the problem with zero service times, mode and maximum—allowing a long tail to be defined similar to that of the Gamma distribution. An example of a histogram based on the Gamma distribution with the Triangular distribution superimposed on it can be seen in FIG. 8.

Every aspect within the simulation model that requires the sampling of a distribution, such as the service times and arrival rates, has a unique random number stream attached to it. The streams are reproducible and therefore when running the model and comparing the results to the same model with an alteration to a resource level, any change in the results is directly attributable to the resource change rather than to any random variation.

Previous studies have identified a sinusoidal arrival pattern indicating that this is a wide spread pattern and that its use is justified for predicting the arrivals departments in general.

The total number of arrivals per day can vary from hospital to hospital and for this reason one of the user interface questions, requests the average number of arrivals per day at the department.

The model is based on 250 arrivals per day, if the answer to the question is more or less than this the sinusoidal curve is scaled to suit.

This is not simply an additional shift, but a multiplying in order to adjust the amplitude of the curve. I.e. in the early hours of the morning there may still small numbers of patients arriving, but the numbers throughout the day are increased or decreased from 250 as the case may be. This means that the regenerative nature of the model is not affected by the scaling. FIG. 9 demonstrates how the scaling effects the number of arrivals per hour of the day, when the number of arrivals per week is altered as per the legend (i.e. 100, 200, 300 arrivals per week).

The creation and/or modification of a simulation model in any software package requires knowledge of both the software and of simulation. It is intended that the generic model will be made available to health service staff either in a Health Board or within hospitals who have an interest in resource allocation within Accident and Emergency departments.

With the desire to make the generic model available to those who would make use of it and because it is likely that their knowledge of the subject of simulation will be limited, in the preferred embodiment it was decided to create a User Interface using Microsoft® Excel and Visual Basic macros.

Object Linked Embedding (OLE) Automation is a way of allowing programmes to control each other. In this case Visual Basic is referred to as the OLE Automation controller and Excel and Witness™ are OLE Automation servers. This means that Excel and Witness™ are controlled by Visual Basic. Not all programmes are capable of being controllers.

The user interface is composed of a series of macros; these are programmes written in Visual Basic™ (Microsoft Corporation 1996). There is one macro for each process with the Accident and Emergency department and several others that will be discussed later which perform the overall control of the model.

Information such as variable names and values, shift patterns and quantities of resources can be entered into Excel™ (Microsoft Corporation 1997) via Visual Basic. If they are in the correct format they can then be read into Witness. This eliminates the need for the user to have any knowledge of the simulation software when entering data.

In order to guarantee the set format of the data that is required in Witness™, it was decided to prompt the user via a series of questions, the answers to which will be automatically entered in to Excel in the correct format.

A macro can call a second macro from within it, the second macro would run and when it is finished control is given back to the macro that called it. Any number of parameters can be passed between the macros if another requires the information.

The relationship between the macros, which control the generic model, can be seen in Table 1. The macros in each column call the macros in the column to the right of it; the rows indicate the order in which the macros are called. When the macro is completed control passes back to the macro that called it.

All of the Level four macros listed in Table 1 follow the same structure. Their purpose is to obtain information from the user on the resources within the department. They each consist of four input boxes; these appear one at a time, and request the information.

The questions posed are:
Does the facility exist?

If yes
How many locations are there for the facility?
What is the x co-ordinate in the display?
What is the y co-ordinate in the display?

The information from the first question is stored in Excel, it is this information that allows the generic model to identify the specific configuration of nodes required for the particular set-up of the model.

If the answer to the first question is NO then the variable processnameUSE is set to 9999. If the answer to the first question is no for any of the level 4 macros and there is no alternative route to the subsequent nodes, then the macros for the subsequent nodes will not be called and the processnameUSE variable for those nodes will automatically be set to 9999. I.e. if P4or5 Triage does not exist then neither does P4or5 Examine, P4or5 diagnosis or P4or5 Treat.

The second question relating to the number of locations available for a particular process is linked to the number of rooms or cubicles in the department. Some hospitals will use all the rooms/cubicles for all processes i.e. they are multipurpose. Other hospitals on the other hand, split the department into areas and the patients move around the areas depending on the stage they are at within the process.

The last two questions relate to the computer display that will be generated when the model is running.

One of the major benefits of visual interactive simulation is the visual display. Acceptance of the model and the results of the simulation are enhanced if the user can relate easily to the model.

When setting up the model, the user can see the Witness™ screen and can enter co-ordinates of each of the facilities, based on a grid that is superimposed on the screen during the set-up stages.

When each of the Level four macros is called a variable, countvar is passed between them. This tallies the number of variables that have been set and ultimately informs Witness of the number of rows to be read from the Excel spreadsheet.

Once the macro is running, it has to know which package will be the OLE Automation server. In the case of the Level 4 macros, Witness is the object to be linked to. The coding below activates this.
Set WitObj=GetObject(, “WITNESS.WCL”)

Any command after this that starts with WitObj. is sending information directly to Witness.

Via an input box, such as is generated from the coding below, the questions are posed and the answers obtained.

triagevar = InputBox( _{—}
prompt:=“Do you have a P4 and P5 triage facility?.”, _{—}
default:=“Yes”)

Information on the processnameUSE variable and on the tally of variables is then stored in Excel.

Sheets(“sheet3”).Select
ActiveCell.Value = “P4or5triageuse”
ActiveCell.Offset(0, 1).Range(“al”).Select
ActiveCell.Value = triageva
ActiveCell.Offset(0, 1).Range(“al”).Select
ActiveCell.Value = countvar
ActiveCell.Offset(1, −2).Range(“al”).Select
countvar = countvar + 1

In order to achieve the required formatting of the data in Excel, the Offset command is utilised to select the correct cell for the data to be placed.

The other information relating to the graphical display is set using the object linking embedded automation to send it directly to Witness.

```
For n = 1 To notriage
    xna_triage = (Val(x_triage) + 25 * (n − 1))
    xnb_triage = xna_triage
    n1 = n
  ‘ icon
    WitObj.Action (“Setposn(P4or5triage(“ + n1 + ”),1,1,“ +
      xnb_triage + ”,“ + y_triage + ”)”)
    y2a_triage = (Val(y_triage) − 15)
    y2b_triage = y2a_triage
  ‘name
    WitObj.Action (“Setposn(P4or5triage,2,1,“ + xnb_triage +
      ”,“ + y2b_triage + ”)”)
    x2a_triage = (Val(xna_triage) − 10)
    x2b_triage = x2a_triage
  ‘ patient
    WitObj.Action (“Setposn(P4or5triage(“ + n1 + ”),3,1,“ +
      x2b_triage + ”,“ + y_triage + ”)”)
    y3a_triage = (Val(y_triage) − 10)
    y3b_triage = y3a_triage
  ‘ labour
    WitObj.Action (“Setposn(P4or5triage(“ + n1 + ”),6,1,“ +
      x2b_triage + ”,“ + y3b_triage + ”)”)
Next n
```

The display is within a loop to cater for the multiple locations in which the process could occur (rooms and cubicles). As can be seen from the code above that the information for the display consist of details regarding the position of the process icon in relation to the patient and the member of staff (labour) dealing with the patient. The name of the process being displayed is also included for clarity. This information is set directly to Witness using the WitObj.Action command.

There is only one macro at level three. The Resources macro is used to control the overall set-up of the model. The main factors of concern are addressed by the following questions:
Are all the P3 and P4or5 category patients dealt with in the same area during the day?

If yes
How many rooms/cubicles are there available?

If no
How many rooms/cubicles are there available for the P3 category patients?
How many rooms/cubicles are there available for the P4or5 category patients?
Are all the P3 and P4or5 category patients dealt with in the same area during the night?

If the answer to the first question is yes, the patients are all dealt with together during the day, then it is not necessary to call the P4or5 level 4 macros and the processnameUSE variables are automatically set to 9999 and stored in Excel.

The final question relates to changes in the operation of the system between at different times of the day. Some hospitals will reduce the size of the department at night due to decrease in the number of patients arriving.

If the answer to the final question is yes, then a variable called sysalter is set to 1 and is stored in Excel.

Three of the level two macros are used to collect data on the shift patterns of the staff. The information entered here is based on Gantt charts.

Again the data is requested and entered via input boxes. Firstly the maximum and minimum numbers of staff, say nurses, is entered. The difference between these two figures is the number of different shifts that will be requested.

For each shift a new Excel file is created with a .sft file extension and the shift data is then entered. I.e. each period on and off shift period is requested.

```
Sheets(“Sheet1”).Select
        on_i = InputBox( _{—}
        prompt:=“Please enter the length of the on shift
            period.”, _{—}
        default:=“120”)
Sheets(“Sheet1”).Select
        off_i = InputBox( _{—}
        prompt:=“Please enter the length of the off shift
          period.”, _{—}
        default:=“60”)
```

The separate shift files are saved and then read by Witness via the OLE link.
WitObj.Action (“readshft(nurseshift”+nurseshift+“,”“c:\\my documents\\using\\shiftsgen\\nurseshift”+nurseshift+“l.sft“”)”)

The Runwit macro prepares Witness for the start of the data entering by activating the grid that enables the user to select the co-ordinates of the facilities.
WitObj.Action (“layeron(4)”)

The average number of patients arriving in the department per year is requested and stored in Excel.
noarrive=InputBox( _{—}
prompt:=“On average how many patients attend the department per day?”, _{—}
default:=“250”)

The default reply is set at 250, as this is the basis of the arrivals as discussed above.

Having called the level three macros control eventually returns to Runwit and the grid is switched off.
WitObj.Action (“layeroff(4)”)

Witness is ready for the simulation to begin and the Experiment macro is called.

The Setup macro is designed to reduce the amount of information required from the user each time they want to run the model for the same configuration.

If the shift patterns have already been entered and are not being altered the three shift macros will be skipped in the set-up.

If the resources and layout have previously been entered and are not being altered all of the level three and four macros will be skipped.

It is possible to run the model exactly as it was previously defined in which case only the Experiment macro will be executed.

The macros do not operate independently of each other and answers from one macro can have a direct impact on the operation of another. For this reason the links between the macros were tested using Control Flow Analysis. This technique examines the sequence of control transfers when conditional branches exist in the overall graph of macro links. FIG. 10 shows which macros are being called in response to the answers provided from questions in the previous macro.

Further modifications and improvements may be added without departing from the scope of the invention herein described.

1. A system comprising:
a plurality of process data items;
means for inputting process information corresponding to at least one process data item from an input unit;
means for setting said at least one process data item responsive to said input process information;
means for selecting said at least one process data item depending on the value of at least one of said process data items and activating said means for inputting process information; and
a data interface means for outputting process data items corresponding to simulation model data.

2. The system of claim 1 wherein said means for inputting process information comprises stored input prompts corresponding to said process information.

3. The system of claim 1 wherein said process data items comprise variables corresponding to said process information.

4. The system of claim 1 wherein said process data items further comprise an exclusion variable for recording whether the corresponding process should be excluded from a simulation.

5. The system of claim 4 wherein said means for selecting at least one process data item is responsive to said exclusion variable.

6. The system of claim 4 wherein said means for setting at least one process data item is responsive to said exclusion variable.

7. A method comprising the steps of:
selecting at least one process data item depending on the value of at least one process data item;
outputting at least one input prompt corresponding to said selected at least one process data item to an output unit;
inputting process information corresponding to said selected at least one process data item from an input unit;
setting at least one process data item responsive to said input process information; and
outputting process data items corresponding to simulation model data.

8. The method of claim 7 further comprises the step of activating the execution of a simulation using said simulation model data.

9. The method of claim 7 wherein said output unit comprises a display unit.

10. The method of claim 7 wherein said process data items comprise variables corresponding to said process information.

11. The method of claim 7 wherein said process data items further comprise an exclusion variable for recording whether the corresponding process should be excluded from a simulation.

12. The method of claim 11 wherein said step of selecting at least one data item is responsive to said exclusion variable.

13. The method of claim 11 wherein said step of setting at least one process data item is responsive to said exclusion variable.
